(19) United States
(12) Patent Application Publication
(10) Pub. No.: US 2025/0112346 A1
(43) Pub. Date: Apr. 3, 2025

(54) METHOD FOR MANUFACTURING BATTERY AND APPARATUS FOR MANUFACTURING BATTERY

(71) Applicant: TOYOTA JIDOSHA KABUSHIKI KAISHA, Toyota-shi (JP)

(72) Inventors: Yosuke SHIMURA, Nagakute-shi (JP); Takahiko NAKANO, Nagoya-shi (JP); Hirokazu TAKEUCHI, Toyota-shi (JP); Masato NODA, Toyota-shi (JP); Atsushi SUGIHARA, Toyota-shi (JP); Jun IZUMI, Toyota-shi (JP); Yuka YOKOI, Nagoya-shi (JP)

(21) Appl. No.: 18/823,507

(22) Filed: Sep. 3, 2024

(30) Foreign Application Priority Data
Oct. 2, 2023 (JP) 2023-171531

(51) Int. Cl. H01M 50/609; B01D 19/00

(52) U.S. Cl. CPC H01M 50/609; B01D 19/0036

(57) ABSTRACT

A method for manufacturing a battery includes: a first step of supplying an electrolytic solution to an internal space of an exterior body in which an electrode body is accommodated; and a second step of supplying the electrolytic solution that has been taken out from the internal space of the exterior body, to the internal space of the exterior body, wherein the second step includes removing bubbles contained in the electrolytic solution that has been taken out from the internal space of the exterior body.

### CROSS-REFERENCE TO RELATED APPLICATION

This application is based on and claims priority under 35 USC 119 from Japanese Patent Application No. 2023-171531, filed on Oct. 2, 2023, the entire disclosure of which is incorporated by reference herein.

### BACKGROUND

### Technical Field

The present disclosure relates to a method for manufacturing a battery and an apparatus for manufacturing a battery.

### Related Art

In a process for manufacturing a battery using an electrolytic solution obtained by dissolving an electrolyte in an organic solvent, a liquid injection operation is performed in which an electrolytic solution is supplied to an interior of an exterior body accommodating an electrode body, and the electrolytic solution is permeated into the electrode body.

In some cases, processing is carried out in which an electrode of the battery is pressed at a high pressure to increase an energy density. When a packing density of an electrode active material within the electrode is increased by pressing the electrode, a permeability of the electrolytic solution decreases. The decrease in the permeability of the electrolytic solution causes a decrease in efficiency of the liquid injection operation.

As a measure to increase the permeability of the electrolytic solution at the time of the liquid injection operation, Japanese Patent Application Laid-Open (JP-A) No. 2015-5331 proposes causing an electrolytic solution to flow at a constant flow rate by continuously discharging the electrolytic solution while supplying the electrolytic solution to the exterior body accommodating the electrode body. According to this method, the electrolytic solution collides with the electrode body while causing turbulence, and a rate of penetration of the electrolytic solution into the electrode body is improved.

In the method described in JP-A No. 2015-5331, there is a possibility that the electrolytic solution in a state of flowing may contain bubbles generated by contact with the electrode body. In that case, there is a possibility that the bubbles contained in the electrolytic solution may hinder penetration of the electrolytic solution into the electrode body.

### SUMMARY

In view of the foregoing, an object of an embodiment of the present disclosure is to provide a novel method of manufacturing a battery and a novel apparatus for manufacturing a battery, in which efficiency of a liquid injection operation of an electrolytic solution is improved.

The means for solving the aforementioned problem include the following embodiments.

<1> A method for manufacturing a battery, the method including:
a first step of supplying an electrolytic solution to an internal space of an exterior body in which an electrode body is accommodated; and
a second step of supplying the electrolytic solution that has been taken out from the internal space of the exterior body, to the internal space of the exterior body,
wherein the second step includes removing bubbles contained in the electrolytic solution that has been taken out from the internal space of the exterior body.

<2> The method for manufacturing a battery according to <1>, wherein the second step includes circulating the electrolytic solution.

<3> The method for manufacturing a battery according to <1> or <2>, wherein the bubbles are removed using a vacuum defoaming device.

<4> The method for manufacturing a battery according to any one of <1> to <3>, wherein an amount of the electrolytic solution in the internal space of the exterior body is an amount such that at least half of the electrode body is immersed.

<5> An apparatus for manufacturing a battery, the apparatus including:
a first supply section that supplies an electrolytic solution to an internal space of an exterior body in which an electrode body is accommodated; and
a second supply section that supplies the electrolytic solution that has been taken out from the internal space of the exterior body, to the internal space of the exterior body,
wherein the second supply section includes a defoaming section that removes bubbles contained in the electrolytic solution that has been taken out from the internal space of the exterior body.

### BRIEF DESCRIPTION OF THE DRAWINGS

Exemplary embodiments of the present disclosure will be described in detail based on the following figures, wherein:

FIG. 1 is a diagram schematically illustrating an example of a method for manufacturing a battery;

FIG. 2 is a diagram schematically illustrating an example of application of a battery module to an electric vehicle;

FIG. 3 is a diagram schematically illustrating an example of a configuration of a battery module;

FIG. 4 is a diagram schematically illustrating an example of a configuration of a battery module; and

FIG. 5 is a diagram schematically illustrating an example of a configuration of a battery cell included in a battery module.

### DETAILED DESCRIPTION

In the present disclosure, a numerical range indicated by using “to” means a range in which numerical values described before and after “to” are included as a minimum value and a maximum value, respectively.

In numerical ranges described in the present disclosure in a stepwise manner, an upper limit value or a lower limit value described in a certain numerical range may be replaced with an upper limit value or a lower limit value of another numerical range described in a stepwise manner. In the numerical ranges described in the present disclosure, an upper limit value or a lower limit value described in a certain numerical range may be replaced with a value indicated in the examples.

In the present disclosure, the term “step” includes not only independent steps, and even in a case in which a step cannot be clearly distinguished from another step, it is encompassed by this term as long as the intended purpose of the step is achieved.

In a case in which an embodiment is explained in the present disclosure with reference to the drawings, the configuration of the embodiment is not limited to the configuration illustrated in the drawings. Furthermore, sizes of members in the respective drawings are conceptual, and relative relationships between sizes of members are not limited thereto.

### <Method for Manufacturing Battery>

A method for manufacturing a battery of the present disclosure includes:
a first step of supplying an electrolytic solution to an internal space of an exterior body in which an electrode body is accommodated; and
a second step of supplying the electrolytic solution that has been taken out from the internal space of the exterior body, to the internal space of the exterior body,
wherein the second step includes removing bubbles contained in the electrolytic solution that has been taken out from the internal space of the exterior body.

When the electrolytic solution is supplied to the internal space of the exterior body, a portion of the supplied electrolytic solution, which is not absorbed by the electrode body immediately after the supplying, remains in the internal space of the exterior body. In a conventional method, the operation is stopped and put on hold until the electrolytic solution remaining in the internal space of the exterior body is absorbed by the electrode body due to a capillary phenomenon or the like. This on-hold time can cause a decrease in operation efficiency. In particular, in a case in which the electrolytic solution is supplied over plural separate times, if the aforementioned on-hold time is long, the operation efficiency tends to decrease.

In contrast, in the method of the present disclosure, in addition to the first step of supplying the electrolytic solution to the internal space of the exterior body, the second step of supplying the electrolytic solution that has been taken out from the internal space of the exterior body, to the internal space of the exterior body, is performed.

By performing the second step, the electrolytic solution in the internal space of the exterior body can be caused to flow. When the electrolytic solution within the exterior body is in a fluidized state, a rate of penetration of the electrolytic solution into the electrode body is increased as compared to a case in which the electrolytic solution is in a stationary (retained) state.

Furthermore, the method of the present disclosure includes removing bubbles contained in the electrolytic solution that has been taken out from the internal space of the exterior body in the second step.

In some cases, the electrolytic solution supplied to the internal space of the exterior body in the first step contains bubbles generated by contact with the electrode body disposed within the exterior body. Bubbles contained in the electrolytic solution can cause penetration of the electrolytic solution into the electrode body to be hindered.

In the method of the present disclosure, bubbles contained in the electrolytic solution that has been taken out from the exterior body are removed before the electrolytic solution is again supplied to the exterior body. As a result, the permeability of the electrolytic solution to the electrode body is favorably maintained.

### (First Step)

In the first step, the electrolytic solution is supplied to the internal space of the exterior body in which the electrode body is accommodated.

The supplying of the electrolytic solution in the first step is performed, for example, using a first pipe that connects a tank in which the electrolytic solution is stored and a first supply port provided at the exterior body.

An amount of the electrolytic solution supplied to the internal space of the exterior body in the first step may be the same as a design amount of the electrolytic solution contained in a battery that is manufactured by the method of the present disclosure, may be less than the design amount, or may be greater than the design amount.

In a case in which the supply amount of the electrolytic solution is less than the design amount of the electrolytic solution, for example, the supplying of the electrolytic solution in the first step is performed plural times.

In a case in which the supply amount of the electrolytic solution is greater than the design amount of the electrolytic solution, for example, an excess portion is removed from the electrolytic solution that has been taken out from the exterior body in the second step. The removed electrolytic solution may be reused in manufacturing of a battery.

In the method of the present disclosure, since the electrolytic solution is taken out from the exterior body in the second step, the amount of the electrolytic solution that is supplied to the internal space of the exterior body in the first step can be greater than the design amount. As a result, a contact area between the electrolytic solution and the electrode body can be increased, and penetration of the electrolytic solution into the electrode body can be efficiently performed.

Among the electrolytic solution supplied in the first step, a portion that is not absorbed by the electrode body is retained in the internal space of the exterior body. From the viewpoint of efficiently penetrating the electrolytic solution into the electrode body, the amount of the electrolytic solution remaining in the internal space of the exterior body is preferably an amount such that at least half of the electrode body is immersed in the electrolytic solution.

### (Second Step)

In the second step, the electrolytic solution that has been taken out from the internal space of the exterior body is supplied to the internal space of the exterior body.

The supplying of the electrolytic solution in the second step is performed, for example, using a second pipe that connects a discharge port for the electrolytic solution provided at the exterior body and a second supply port for the electrolytic solution provided at the exterior body.

The second step may include circulating the electrolytic solution. In other words, the step of supplying the electrolytic solution that has been taken out from the internal space of the exterior body, to the internal space of the exterior body, may be continuously repeated.

The second step includes removing bubbles contained in the electrolytic solution that has been taken out from the internal space of the exterior body.

A method for removing the bubbles contained in the electrolytic solution is not particularly limited, and can be carried out using a known defoaming device. Examples of the defoaming device include a vacuum defoaming device, a centrifugal defoaming device, an ultrasonic defoaming device and the like, and among these, a vacuum defoaming device is preferable.

From the viewpoint of efficiently penetrating the electrolytic solution into the electrode body, it is preferable that the discharge port for taking out the electrolytic solution from the exterior body be provided further downward in a gravity direction than the second supply port for supplying the electrolytic solution to the exterior body.

From the viewpoint of efficiently penetrating the electrolytic solution into the electrode body, the second step is preferably performed while depressurizing the internal space of the exterior body.

The second step may be performed using a motive power source such as a pump or the like.

Hereinafter, embodiments of the present disclosure will be explained with reference to the drawings.

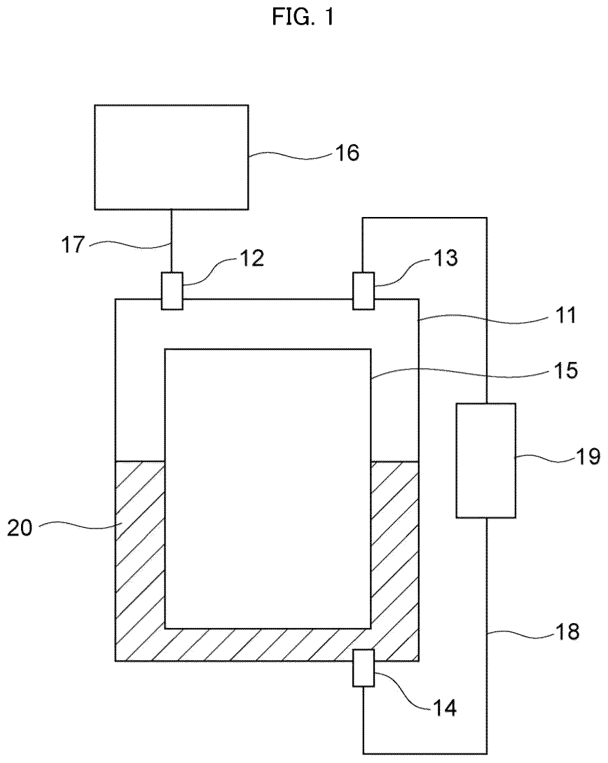

FIG. 1 is a diagram schematically illustrating an example of a method for manufacturing a battery.

An exterior body 11 shown in FIG. 1 has a first supply port 12, a second supply port 13, and a discharge port 14 for supplying or discharging an electrolytic solution. An electrode body 15 is disposed in an internal space of the exterior body 11.

The first supply port 12 is connected to a tank 16, which stores the electrolytic solution, by a first pipe 17.

The second supply port 13 is connected to one end of a second pipe 18, and the discharge port 14 is connected to another end of the second pipe 18.

A defoaming device 19 for removing bubbles contained in the electrolytic solution is connected to the second pipe 18.

The electrolytic solution 20, which has been supplied from the tank 16 via the first pipe 17, is retained in the internal space of the exterior body 11. The electrolytic solution 20 contains bubbles (not illustrated in the drawings) that have been generated by contact with the electrode body 15 or the like.

The electrolytic solution 20 is taken out from the discharge port 14 of the exterior body 11, passes through the second pipe 18, and is supplied again from the second supply port 13 of the exterior body 11 to the internal space of the exterior body 11.

Before the electrolytic solution 20 that has been taken out from the internal space of the exterior body 11 is supplied again to the internal space of the exterior body 11, the bubbles are removed by the defoaming device 19 provided at the second pipe 18.

When a sufficient amount of the electrolytic solution 20 has been absorbed by the electrode body 15, the first step of supplying the electrolytic solution 20 from the tank 16 to the internal space of the exterior body 11, and the second step of supplying the electrolytic solution that has been taken out from the exterior body 11, to the exterior body 11, are repeated as necessary.

When a design amount of the electrolytic solution 20 has been supplied to the exterior body 11, the first supply port 12, the second supply port 13, and the discharge port 14 are sealed.

In an embodiment, a material configuring the exterior body 11 may be a laminated body (so-called laminate film) having a metal layer containing a metal such as aluminum or the like and a heat seal layer containing a resin that is melted by heating. In other words, the battery manufactured by the method of the present disclosure may be a battery (so-called laminate battery) including the exterior body 11, which is obtained by bonding a periphery of a laminate film.

The exterior body 11 may be configured from one member as shown in FIG. 1, or may be configured from two or more members.

### <Apparatus for Manufacturing Battery>

An apparatus for manufacturing a battery of the present disclosure includes:
a first supply section that supplies an electrolytic solution to an internal space of an exterior body in which an electrode body is accommodated; and
a second supply section that supplies the electrolytic solution that has been taken out from the internal space of the exterior body, to the internal space of the exterior body,
wherein the second supply section includes a defoaming section that removes bubbles contained in the electrolytic solution that has been taken out from the internal space of the exterior body.

A configuration of the first supply section in the apparatus of the present disclosure is not particularly limited as long as it is a configuration that is capable of supplying the electrolytic solution to the internal space of the exterior body in which the electrode body is accommodated.

The first supply section may include, for example, a first pipe that connects a tank in which the electrolytic solution is stored and a first supply port provided at the exterior body.

A configuration of the second supply section in the apparatus of the present disclosure is not particularly limited as long as it is a configuration that is capable of supplying the electrolytic solution that has been taken out from the internal space of the exterior body, to the internal space of the exterior body.

The second supply section may include, for example, a second pipe that connects a discharge port for taking out the electrolytic solution from the exterior body, and a second supply port for supplying the electrolytic solution to the exterior body again.

A configuration of the defoaming section included in the second pipe is not particularly limited, and can be selected from known defoaming devices.

For details and preferred aspects of a method for using the apparatus of the present disclosure, reference can be made to the content that has been described for the above-described method for manufacturing a battery of the present disclosure.

### (Battery)

A type of battery that is manufactured by the method of the present disclosure is not particularly limited.

Specific examples of the battery include secondary batteries such as lithium-ion secondary batteries, lead storage batteries, nickel-hydrogen storage batteries, nickel-cadmium storage batteries, nickel-iron storage batteries, nickel-zinc storage batteries, silver oxide-zinc storage batteries, cobalt-titanium-lithium secondary batteries, and the like.

From the viewpoints of energy density, versatility, and the like, the battery may be a lithium-ion secondary battery.

The lithium-ion secondary battery includes, for example, a positive electrode, a negative electrode, a separator that is disposed between the positive electrode and the negative electrode, and an electrolytic solution.

The positive electrode includes, for example, a current collector and a positive electrode layer that is disposed on the current collector. The positive electrode layer contains a positive electrode active material.

Examples of a positive electrode active material include composite oxides formed of lithium and a transition metal, and optionally other metals (hereinafter, also referred to as lithium transition metal composite oxides). Examples of the transition metal and other metals include Ni, Co, Mn, Al, B, Mg, Ti, V, Cr, Fe, Cu, Zn, Ga, Sr, Zr, Nb, In, Sn, Ta, W, and the like.

Examples of the lithium transition metal composite oxide include layered lithium transition metal composite oxides, spinel-type lithium transition metal composite oxides, olivine-type lithium transition metal composite oxides, and the like.

Examples of the layered lithium transition metal composite oxide include those containing at least one selected from Ni, Co, or Mn as the transition metal. Specific examples thereof include compounds represented by a structural formula of LiNiₐCo_{b}Mn_{c}O₂ (in which each of a, b, and c is a number of 0 or more and 1 or less, and a+b+c=1), and compounds in which one or more elements selected from Al, Mg, La, Ti, Zn, B, W, Fe, Cr, V, Ru, Cu, Cd, Ag, Y, Sc, Ga, In, As, Sb, Pt, Au, Si, or the like are added to the aforementioned compounds.

Specific examples of the spinel-type lithium transition metal composite oxide include LiMn₂O₄.

Specific examples of the olivine-type lithium transition metal composite oxide include LiMPO₄ (in which M is Fe, Co, Ni or Mn).

The positive electrode active material contained in the positive electrode layer may be one kind alone, or may be two or more kinds thereof.

The positive electrode layer may contain, in addition to the positive electrode active material, components such as a conductivity aid, a binder, and the like.

Examples of a material configuring the current collector of the positive electrode include aluminum, aluminum alloys, nickel, titanium, stainless steel, and the like. Examples of a shape of the current collector include a foil, a mesh, and the like.

The negative electrode includes, for example, a current collector and a negative electrode layer disposed on the current collector and containing a negative electrode active material.

Examples of types of the negative electrode active material include carbon materials such as graphite, hard carbon, soft carbon, activated carbon and the like, silicon, metallic lithium, lithium alloys, lithium titanate (LTO), and the like.

The negative electrode layer may contain, in addition to the negative electrode active material, components such as a conductivity aid, a binder, and the like.

Examples of a material configuring the current collector of the negative electrode include copper, copper alloys, nickel, titanium, stainless steel, and the like. Examples of a shape of the current collector of the negative electrode include a foil, a mesh, and the like.

Examples of the separator include nonwoven fabrics, cloths, microporous films or the like containing a polyolefin such as a polyethylene, a polypropylene, or the like, as a main component. In a case in which a solid electrolyte is used in the lithium-ion secondary battery, it is not necessary for a separator to be used.

As the electrolytic solution, an electrolytic solution in which a known lithium salt such as LiPF₆ is dissolved in an organic solvent can be used without any particular limitation.

The battery of the present disclosure may be mounted at an electric vehicle. Hereinafter, an example in which the battery of the present disclosure is applied to an electric vehicle will be explained with reference to the drawings. In the following explanation, a “battery cell 20” corresponds to the battery of the present disclosure.

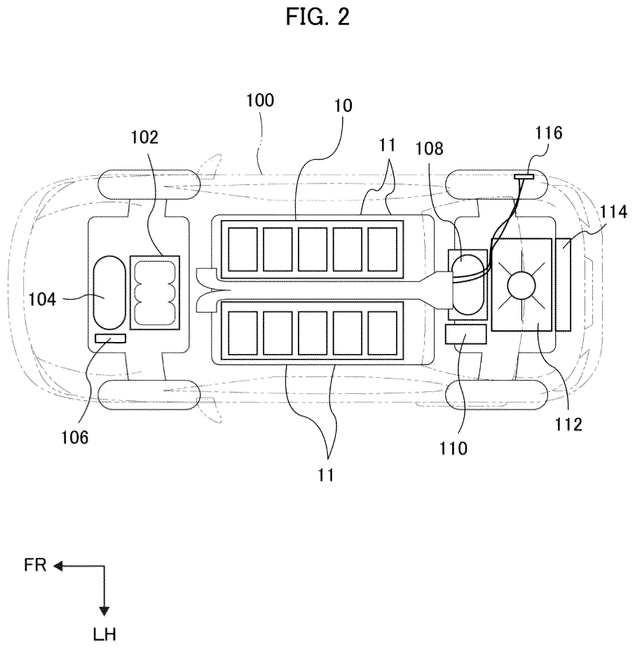

FIG. 2 is a schematic plan view illustrating a main part of a vehicle 100 to which a battery pack 10 according to an embodiment has been applied. As shown in FIG. 2, the vehicle 100 is an electric vehicle (battery electric vehicle (BEV)) in which the battery pack 10 is mounted under a floor. It should be noted that arrow UP, arrow FR, and arrow LH in the respective drawings respectively indicate an upper side in a vehicle up-down direction, a front side in a vehicle front-rear direction, and a left side in a vehicle width direction. In cases in which explanation is given using front-rear, left-right, and up-down directions, unless otherwise specified, these indicate front and rear in the vehicle front-rear direction, left and right in the vehicle width direction, and up and down in the vehicle up-down direction.

As an example, in the vehicle 100 of the present embodiment, a DC/DC converter 102, an electric compressor 104, and a positive temperature coefficient (PTC) heater 106 are disposed further toward a vehicle front side than the battery pack 10. Further, a motor 108, a gear box 110, an inverter 112, and a charger 114 are disposed further toward a vehicle rear side than the battery pack 10.

A DC current that has been output from the battery pack 10 is adjusted in voltage by the DC/DC converter 102, and thereafter supplied to the electric compressor 104, the PTC heater 106, the inverter 112, and the like. Furthermore, due to electric power being supplied to the motor 108 via the inverter 112, rear wheels rotate to drive the vehicle 100.

A charging port 116 is provided at a right side portion of a rear portion of the vehicle 100. By connecting a charging plug of an external charging facility, which is not illustrated in the drawings, from the charging port 116, electric power can be stored in the battery pack 10 via the charger 114.

An arrangement, structure and the like of the respective components configuring the vehicle 100 are not limited to the configuration described above. For example, the present disclosure may be applied to vehicles installed with an engine such as hybrid vehicles (HV) and plug-in hybrid electric vehicles (PHEV). Further, in the present embodiment, although the vehicle is configured as a rear-wheel drive vehicle in which the motor 108 is mounted at the rear portion of the vehicle, there is no limitation thereto; the vehicle may be configured as a front-wheel drive vehicle in which the motor 108 is mounted at the front portion of the vehicle, and a pair of motors 108 may also be mounted at the front and rear of the vehicle. Furthermore, the vehicle may also be provided with in-wheel motors at the respective wheels.

The battery pack 10 is configured to include plural battery modules 11. In the present embodiment, as an example, ten battery modules 11 are provided. Specifically, five battery modules 11 are arranged in the vehicle front-rear direction at the right side of the vehicle 100, and five battery modules 11 are arranged in the vehicle front-rear direction at the left side of the vehicle 100. Furthermore, each of the battery modules 11 are electrically connected to each other.

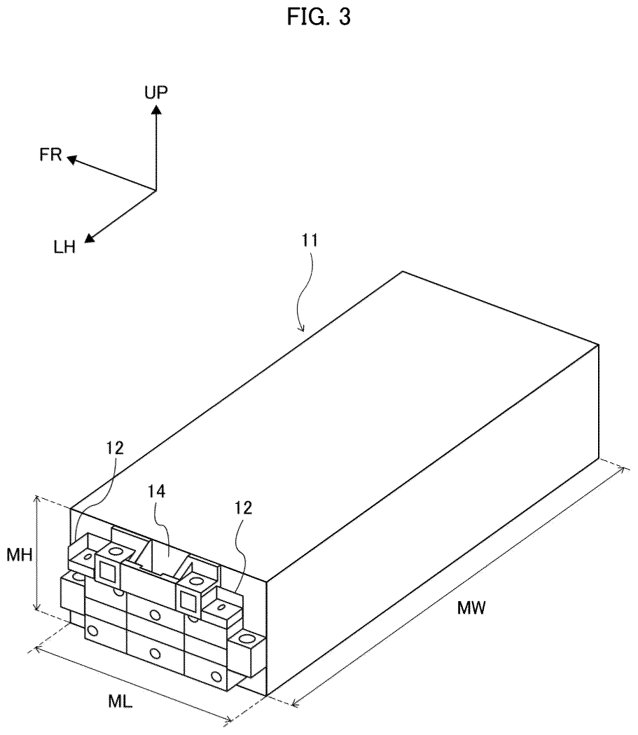

FIG. 3 is a schematic perspective view of a battery module 11. As shown in FIG. 3, the battery module 11 is formed in a substantially rectangular parallelepiped shape having a longitudinal direction along the vehicle width direction. Furthermore, an outer shell of the battery module 11 is formed of an aluminum alloy. For example, the outer shell of the battery module 11 is formed by joining aluminum die-casting to both ends of an extruded material of an aluminum alloy by laser welding or the like.

A pair of voltage terminals 12 and a connector 14 are provided at both ends of the battery module 11 in the vehicle width direction. A flexible printed circuit board 21, which will be described later, is connected to the connector 14. Furthermore, bus bars, which are not illustrated in the drawings, are welded to both ends of the battery module 11 in the vehicle width direction.

A length MW of the battery module 11 in the vehicle width direction is, for example, from 350 mm to 600 mm; a length ML thereof in the vehicle front-rear direction is, for example, from 150 mm to 250 mm; and a height MH thereof in the vehicle up-down direction is, for example, from 80 mm to 110 mm.

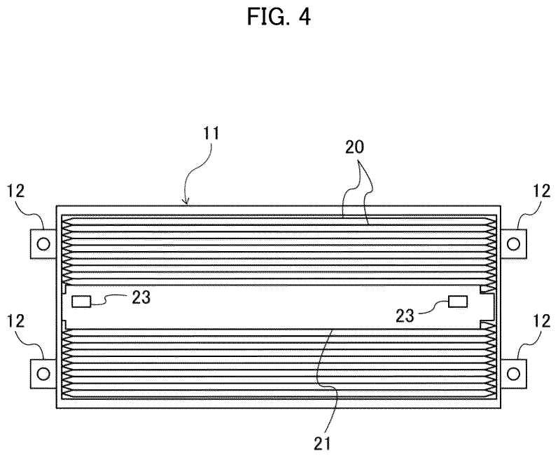

FIG. 4 is a plan view of the battery module 11 in a state in which an upper lid thereof has been removed. As shown in FIG. 4, plural battery cells 20 are accommodated at an interior of the battery module 11 in an arranged state. In the present embodiment, as an example, twenty-four battery cells 20 are arranged in the vehicle front-rear direction and are adhered to each other.

A flexible printed circuit (FPC) board 21 is disposed on the battery cells 20. The flexible printed circuit board 21 is formed in a band shape with a longitudinal direction thereof along the vehicle width direction, and thermistors 23 are respectively provided at both end ends of the flexible printed circuit board 21. The thermistors 23 are not adhered to the battery cells 20 and are configured to be pressed toward the battery cells 20 side by the upper lid of the battery module 11.

Furthermore, one or more cushioning materials, which are not illustrated in the drawings, are accommodated at the interior of the battery module 11. For example, the cushioning material is a thin plate-shaped member that is elastically deformable, and is disposed between adjacent battery cells 20 with a thickness direction thereof along an arrangement direction of the battery cells 20. In the present embodiment, as an example, cushioning materials are disposed at both end portions in the longitudinal direction of the battery module 11 and at the center portion in the longitudinal direction, respectively.

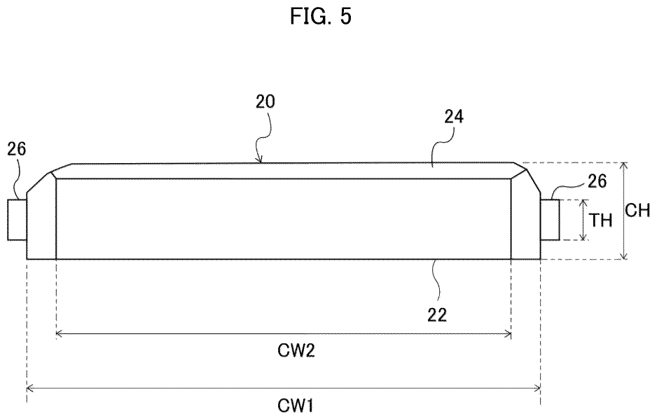

FIG. 5 is a schematic diagram in which a battery cell 20 that is accommodated in the battery module 11 is viewed from a thickness direction thereof. As shown in FIG. 5, the battery cell 20 is formed in a substantially rectangular plate shape, and an electrode body, which is not shown in the drawings, is accommodated at an interior thereof. The electrode body is configured by laminating a positive electrode, a negative electrode, and a separator, and is sealed by a laminate film 22.

In the present embodiment, as an example, the embossed, sheet-shaped laminate film 22 is folded and bonded to thereby form a housing portion of the electrode body. The laminate film 22 may have either a single-cup embossing structure in which embossing is at one place or a double-cup embossing structure in which embossing is at two places. In an embodiment, the laminate film 22 has a single-cup embossing structure with a draw depth of from about 8 mm to 10 mm.

Upper ends of both longitudinal direction end portions of the battery cell 20 are folded over, and corners thereof form an outer shape. Furthermore, an upper end portion of the battery cell 20 is folded over, and a fixing tape 24 is wound around the upper end portion of the battery cell 20 along the longitudinal direction.

Terminals (tabs) 26 are respectively provided at both ends in the longitudinal direction of the battery cell 20. In the present embodiment, as an example, the terminals 26 are provided at positions that are offset downward from the center of the battery cell 20 in the up-down direction. The terminals 26 are connected to the bus bars, which are not illustrated in the drawings, by laser welding or the like.

For example, the battery cell 20 has a length CW1 in the vehicle width direction of from 530 mm to 600 mm, from 600 mm to 700 mm, from 700 mm to 800 mm, from 800 mm to 900 mm, or greater than or equal to 1000 mm; a length CW2 of the region in which the electrode body is housed of from 500 mm to 520 mm, from 600 mm to 700 mm, from 700 mm to 800 mm, from 800 to 900 mm, or greater than or equal to 1000 mm; a height CH of from 80 mm to 110 mm or from 110 mm to 140 mm; a thickness of from 5.0 mm to 7.0 mm, from 7.0 mm to 9.0 mm, or from 9.0 mm to 11.0 mm; and a height TH of the terminal 26 of from 40 mm to 50 mm, from 50 mm to 60 mm, or from 60 mm to 70 mm.

All publications, patent applications, and technical standards mentioned in the present specification are incorporated herein by reference to the same extent as if each individual publication, patent application, or technical standard was specifically and individually indicated to be incorporated by reference.

What is claimed is:

1. A method for manufacturing a battery, the method comprising:
a first step of supplying an electrolytic solution to an internal space of an exterior body in which an electrode body is accommodated; and
a second step of supplying the electrolytic solution that has been taken out from the internal space of the exterior body, to the internal space of the exterior body,
wherein the second step includes removing bubbles contained in the electrolytic solution that has been taken out from the internal space of the exterior body.

2. The method for manufacturing a battery according to claim 1, wherein the second step includes circulating the electrolytic solution.

3. The method for manufacturing a battery according to claim 1, wherein the bubbles are removed using a vacuum defoaming device.

4. The method for manufacturing a battery according to claim 1, wherein an amount of the electrolytic solution in the internal space of the exterior body is an amount such that at least half of the electrode body is immersed.

5. An apparatus for manufacturing a battery, the apparatus comprising:
a first supply section that supplies an electrolytic solution to an internal space of an exterior body in which an electrode body is accommodated; and
a second supply section that supplies the electrolytic solution that has been taken out from the internal space of the exterior body, to the internal space of the exterior body,
wherein the second supply section includes a defoaming section that removes bubbles contained in the electrolytic solution that has been taken out from the internal space of the exterior body.
